(19) United States
(12) Patent Application Publication
(10) Pub. No.: US 2013/0048339 A1
(43) Pub. Date: Feb. 28, 2013

(54) TRANSPARENT ELECTRODES BASED ON GRAPHENE AND GRID HYBRID STRUCTURES

(71) Applicants: James M. Tour, Bellaire, TX (US); Yu Zhu, Akron, OH (US)

(72) Inventors: James M. Tour, Bellaire, TX (US); Yu Zhu, Akron, OH (US)

(73) Assignee: William Marsh Rice University, Houston, TX (US)

(21) Appl. No.: 13/583,372

(22) PCT Filed: Mar. 8, 2011
(86) PCT No.: PCT/US11/27556

§ 371 Date: Nov. 14, 2012

Related U.S. Application Data
(60) Provisional application No. 61/433,702, filed on Jan. 18, 2011.
(60) Provisional application No. 61/347,700, filed on May 24, 2010.
(60) Provisional application No. 61/311,615, filed on Mar. 8, 2010.

(51) Int. Cl. H01B 5/00; B32B 37/12; B82Y 30/00; B82Y 99/00

(52) U.S. Cl. 174/126.1; 156/60; 977/742; 977/773; 977/755; 977/750; 977/752; 977/932; 977/777; 977/734

(57) ABSTRACT

In some embodiments, the present invention provides transparent electrodes that comprise: (1) a grid structure; and (2) a graphene film associated with the grid structure. In additional embodiments, the transparent electrodes of the present invention further comprise a substrate, such as glass. Additional embodiments of the present invention pertain to methods of making the above-described transparent electrodes. Such methods generally comprise: (1) providing a grid structure; (2) providing a graphene film; and (3) associating the graphene film with the grid structure. In further embodiments, the methods of the present invention also comprise associating the transparent electrode with a substrate.

### CROSS REFERENCE TO RELATED APPLICATIONS

This application claims priority to U.S. Provisional Patent Application Nos. 61/311,615, filed on Mar. 8, 2010; 61/347,700, filed on May 24, 2010; and 61/433,702, filed on Jan. 18, 2011. This application is also related to the PCT Application entitled “Growth of Graphene Films from Non-gaseous Carbon Sources”, concurrently being filed herewith on Mar. 8, 2011. The entirety of each of the above-referenced applications is incorporated herein by reference.

### STATEMENT REGARDING FEDERALLY SPONSORED RESEARCH

This invention was made with government support under the U.S. Navy Office of Naval Research Grant No. N000014-09-1-1066; the U.S. Air Force Research Laboratory Grant No. FA 8650-05-D-5807; and the U.S. Air Force Office of Scientific Research Grant No. FA 9550-09-1-0581, all awarded by the U.S. Department of Defense. The government has certain rights in the invention.

### BACKGROUND OF THE INVENTION

Transparent electrode structures have many applications in optoelectronics. Current transparent electrodes suffer from various limitations, including low conductivity, high sheet resistance, low transparency, brittleness and high cost. Therefore, there is currently a need to develop more optimal transparent electrodes and provide effective ways of making them.

### BRIEF SUMMARY OF THE INVENTION

In some embodiments, the present invention provides transparent electrodes that comprise: (1) a grid structure; and (2) a graphene film associated with the grid structure. In some embodiments, the grid structure is selected from the group consisting of metals, carbon nanotubes, graphite, amorphous carbons, metal particles (e.g., metal nanoparticles and metal microparticles) and combinations thereof. In some embodiments, the graphene film is positioned on a top surface of the grid structure and adhesively associated with the grid structure.

In additional embodiments, the transparent electrodes of the present invention further comprise a substrate, such as glass, quartz, boron nitride, silicon and polymers (e.g., polyethylene terephthalate (PET)). In some embodiments, the substrate is beneath the grid structure and the graphene film. In some embodiments, the grid structure is positioned on a top surface of the substrate, and the graphene film is positioned on a top surface of the grid structure. In preferred embodiments, the transparent electrodes of the present invention have transparencies of more than about 70% in a wavelength region between about 400 nm and about 1200 nm (e.g., 550 nm). In more specific embodiments, the transparent electrodes of the present invention have transparencies of more than about 79% in the same wavelength region.

Additional embodiments of the present invention pertain to methods of making the above-described transparent electrodes. Such methods generally comprise: (1) providing a grid structure; (2) providing a graphene film; and (3) associating the graphene film with the grid structure. In some embodiments, the graphene film is provided by one or more methods such as chemical vapor deposition, growth of a carbon source (e.g., a solid carbon source, such as a polymer) on a catalyst surface, (e.g., metal surface) reduction of graphene oxide, splitting of carbon nanotubes, spraying of graphene particles or precursors, or exfoliation of graphite. In some embodiments, the graphene film is positioned on a top surface of the grid structure after formation. In additional embodiments, the associating of the graphene film with the grid structure also comprises an annealing step that adhesively associates the grid structure with the graphene film.

In further embodiments, the methods of the present invention also comprise associating the transparent electrode with a substrate. In some embodiments, the association comprises: (1) positioning the grid structure on a top surface of the substrate, and (2) positioning the graphene film on a top surface of the grid structure. In additional embodiments, the above-described methods also involve an annealing step that adhesively associates the above-mentioned components.

As set forth in more detail below, the transparent electrodes of the present invention provide numerous improved properties over the transparent electrodes of the prior art, especially in terms of transparency, conductivity and sheet resistance. The transparent electrodes of the present invention also provide numerous optoelectronic-related applications, including applications in organic photovoltaics, organic light emitting devices, liquid crystal display devices and touch screens.

### BRIEF DESCRIPTION OF THE FIGURES

In order that the manner in which the above recited and other advantages and objects of the invention are obtained, a more particular description of the invention briefly described above will be rendered by reference to specific embodiments thereof, which are illustrated in the appended Figures. Understanding that these Figures depict only typical embodiments of the invention and are therefore not to be considered limiting of its scope, the invention will be described with additional specificity and detail through the use of the accompanying Figures in which:

FIG. 1 depicts different arrangements of transparent electrodes, in accordance with specific embodiments of the present invention.

FIG. 1A depicts transparent electrode 10, where graphene film 12 is on top of grid structure 14 and substrate 16.

FIG. 1B depicts transparent electrode 20, where graphene film 22 is sandwiched between grid structure 24 and substrate 26.

FIG. 1C depicts a more specific embodiment of the transparent electrode structure shown in FIG. 1A, where the grid structure is a metal grid and the substrate is transparent. The metal grids are depicted as the white lines on the substrate. The graphene molecular structure and the grid are not to scale wherein the grid spacing is in reality much larger than the graphene lattice size.

FIGS. 1D-1E show more optical images of metal grids on transparent substrates. In this embodiment, the metal grid is an Au grid, and the transparent substrate is glass. The Au grid size is 100 μm, and the grid lines have a width of about 10 μm.

FIGS. 1F-1G show optical microscope images of graphene grown on a copper foil. The grain boundaries have sizes of hundreds of μm.

FIG. 2 shows an exemplary method of forming a transparent electrode in accordance with some embodiments of the present invention.

Schemes A1-A4 depict the preparation of the metal grid on a transparent substrate, where A1 represents the deposition of metal film (Metal 1) and photoresist on the transparent substrate; A2 depicts photolithography patterning of the grid structure; A3 depicts wet-etching of the metal film; and A4 depicts the removal of the photoresist.

Schemes B1-B4 depict the preparation of the graphene film by using a solid carbon source (PMMA), where B1 depicts spin-coating PMMA on a copper foil (Metal 2); B2 depicts growing the graphene film using a solid carbon source; B3 depicts spin-coating a PMMA sacrificial layer on graphene; and B4 depicts wet etching of the copper foil.

Schemes AB1-AB2 depict the assembly of the hybrid electrode, where AB1 depicts the transferring of graphene to the top surface of the metal grid structure; and AB2 depicts the removal of PMMA sacrificial layer by dissolution in acetone.

FIG. 3 shows the analysis and comparison of various transparent electrodes.

FIG. 3A shows transmittance (black axis), sheet resistance (blue axis) and charge carrier density (red axis) of graphene transparent electrodes. The orange dots are the hybrid graphene electrodes used in this work. The black dots are undoped CVD graphene on the same plane as hybrid graphene. The red dots are HNO₃ doped graphene, which matched the calculated results. The purple dots are AuCl₃ doped graphene. Since their carrier density is not reported, the data points were placed midway between 10¹² and 10¹³ cm⁻².

FIG. 3B shows transmittance and sheet resistance of the hybrid graphene electrodes compared to commercial transparent electrode materials and previous research results.

FIG. 3C shows the transmittance of various metal grids and hybrid films. See Table 2 for additional details.

FIG. 3D shows photos of hybrid graphene films on glass and PET substrates. In the upper part of FIG. 3D, from left to right, are photos of the graphene/copper grid hybrid (200×200×5 μm) electrode on PET; the graphene/gold grid hybrid (100×100×10 μm) electrode on glass; and the graphene/copper grid hybrid (100×100×10 μm) electrode on glass, respectively. The bottom photo is a bent graphene/copper grid hybrid electrode on PET.

FIG. 4 shows spectroscopic and SEM analyses of the transparent electrodes used in FIG. 3.

FIG. 4A shows Raman spectrum of the graphene used in FIG. 3. The spectrum was taken using transferred graphene on SiO₂ surface.

FIG. 4B shows Raman spectra of the graphene while on the metal grid covered glass. The inset image shows the path where the Raman spectra were taken. The scale bar in inset is 20 μm.

FIGS. 4C-4D show SEM images of the hybrid transparent electrode. Graphene covered areas are darker and flat.

FIG. 5 shows optical images of various grid structures.

FIG. 5A shows optical images of Cu grid on glass. The Cu grid size is 200 μm, and the grid lines have a width of 5 μm.

FIG. 5B shows optical images of Al grid on glass. The Al grid size is 100 μm, and the grid lines have a width of 10 μm.

FIG. 5C shows optical images of Cu grid on PET. The Cu grid size is 100 μm, and the grid lines have a width of 10 μm.

FIG. 5D shows optical images of Al grid on PET. The Al grid size is 200 μm, and the grid lines have a width of 5 μm.

FIG. 6 shows microscope photos of various graphene/metal grid hybrid electrodes. Graphene covers the lower part of all the images, as indicated by the red dashed lines.

FIG. 6A shows optical microscope images of a graphene/gold grid hybrid electrode on glass. The grid size is 100 μm, and the grid line width is 10 μm.

FIG. 6B shows optical microscope images of a graphene/copper grid hybrid electrode on glass. The grid size is 200 μm, and the grid line width is 5 μm.

FIG. 6C shows optical microscope images of a graphene/aluminum grid hybrid electrode on glass. The grid size is 200 μm, and the grid line width is 5 μm.

FIG. 6D shows optical microscope images of a graphene/copper grid on PET. The grid size is 200 μm, and the grid line width is 5 μm.

FIG. 6E shows optical microscope images of graphene/aluminum grid on PET. The grid size is 200 μm, and the grid line width is 5 μm.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

By way of background, the most commonly used transparent electrodes are conducting oxides, such as indium-tin-oxide (ITO) on glass. However, due to their brittle nature and cost, such transparent electrodes can be inadequate for many emerging applications, including flexible solar cells and organic light emitting diodes (OLEDs). For instance, ITO has a brittle nature. Furthermore, the indium component of ITO is sometimes being projected as a scarce commodity, and the cost of the overall ITO can limit its field of applications.

Moreover, current transparent electrodes have limitations in terms of resistance, conductivity, and transparency. For instance, various ITO electrodes (e.g., ITO electrodes with thicknesses of about 160˜200 nm) can reach a sheet resistance of 10 Ω/sq with about 83% transmittance at 550 nm. However, such ITO's do not have identical absorption in the whole visible spectrum region. Consequently, it is desirable to develop more cost efficient transparent electrodes with better transmittance and lower sheet resistance. Generally, ITO gives about 30 to 100 Ω/sq at 90% transparency measured at the often-used standard wavelength of 550 nm.

Accordingly, the present invention provides improved transparent electrodes and methods of making them. The transparent electrodes of the present invention typically comprise: (1) a grid structure; and (2) a graphene film associated with the grid structure. In additional embodiments, the transparent electrodes of the present invention further comprise (3) a substrate, such as a glass. As discussed in more detail below, the transparent electrodes of the present invention can have various arrangements and embodiments.

Another aspect of the present invention provides methods of making the aforementioned transparent electrodes. Such methods generally comprise: (1) providing a grid structure; (2) providing a graphene film; and (3) associating the graphene film with the grid structure. In further embodiments, the methods of the present invention also comprise associating the transparent electrode with a substrate. As also discussed in more detail below, the methods of the present invention have many variations.

Various aspects of the aforementioned transparent electrodes and methods of making them will now be discussed in more detail below. However, Applicants note that the description below pertains to specific and non-limiting examples of how a person of ordinary skill in the art can make and use the transparent electrodes of the present invention.

Transparent Electrode Structures

Transparent electrodes of the present invention generally comprise: (1) a grid structure; a (2) graphene film; and an optional (3) substrate. The aforementioned components can be arranged and associated with each other in different ways. In addition, each of the above components can consist of different compositions of matter.

Grid Structures

Grid structures in the present invention generally refer to network structures that are capable of delivering electricity. A person of ordinary skill in the art will recognize that numerous materials may be used as grid structures. Non-limiting examples include metals, carbon nanotubes, graphite, amorphous carbons, metal particles (e.g., metal nanoparticles or metal microparticles) and combinations thereof.

For instance, non-limiting examples of metals that can be used as grid structures include, without limitation, Au, Pt, Cu, Ag, Al, Ni and combinations thereof. Furthermore, in some embodiments, one or more of the above-mentioned metals can also be associated with carbon nanotubes, graphite, or amorphous carbons in the grid structures of the present invention.

Likewise, non-limiting examples of carbon nanotubes that can be used as grid structures include single-walled carbon nanotubes, multi-walled carbon nanotubes, double-walled carbon nanotubes, ultrashort carbon nanotubes, and combinations thereof. In some embodiments, carbon nanotubes in grid structures may be associated with one or more surfactants or polymers in order to help with dispersibility. In further embodiments, the carbon nanotubes may be pristine carbon nanotubes. In additional embodiments, the carbon nantoubes may be functionalized carbon nanotubes.

Likewise, the grid structures of the present invention can have numerous arrangements and patterns. Non-limiting examples include one or combinations of the following patterns: crossbars, stripes, circles, random, diamonoid, rectangles, spheroid, parallelogram or hatched.

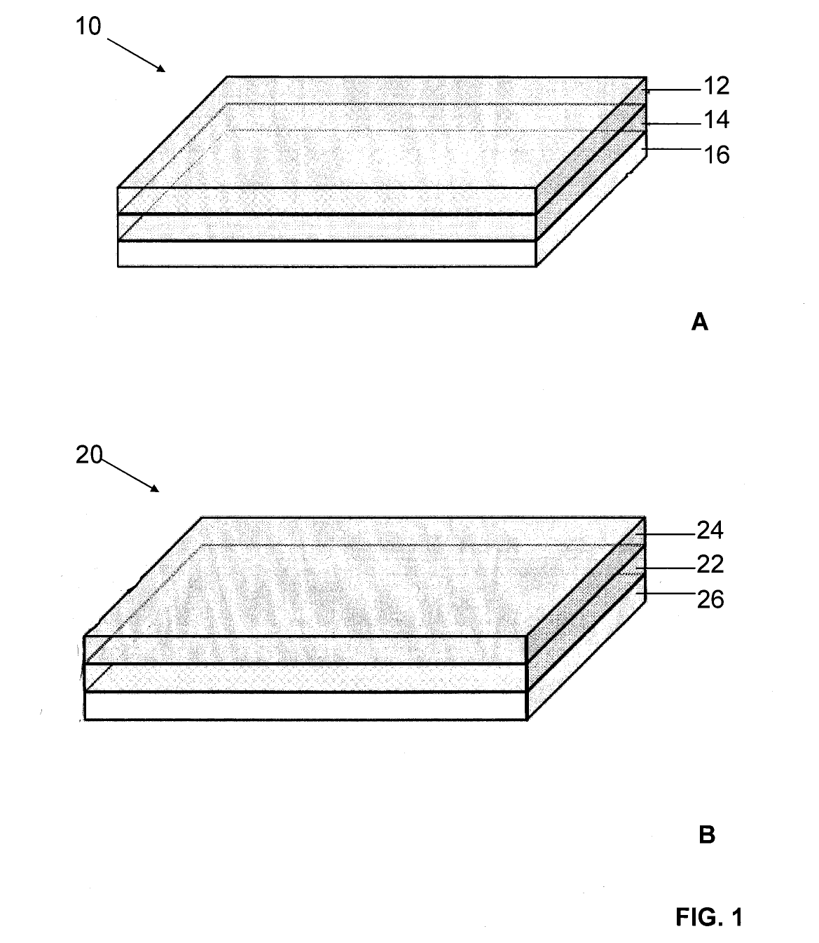

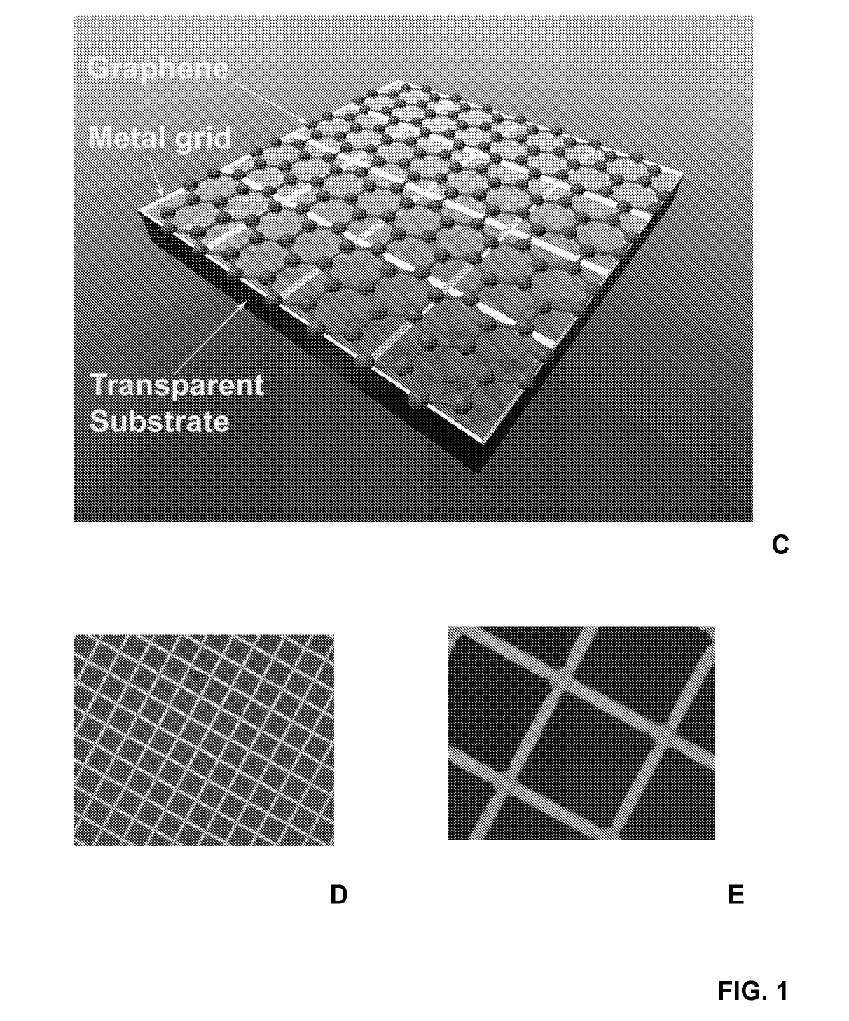

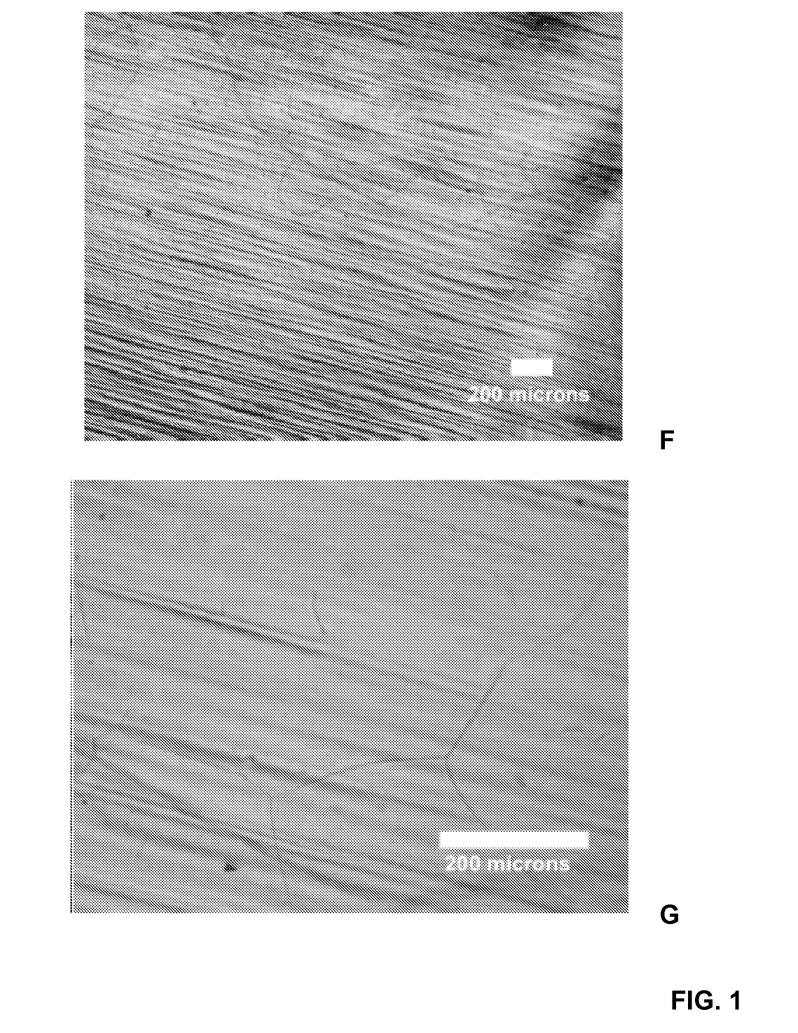

FIGS. 1A-1E show non-limiting examples of various metal grid structures. More specifically, FIG. 1C shows the grid structure to be a cross-barred metal grid sandwiched between a transparent substrate and a graphene film. Likewise, FIGS. 1D-1E show optical images of a transparent electrode with a cross-bar shaped Au grid on a transparent glass with grid sizes of about 100 μm and grid line widths of about 10 μm. A person of ordinary skill in the art can also envision other suitable grid structures with different sizes and lengths.

Graphene Films

In the present invention, graphene films generally refer to allotropes of carbon that are arranged as one-atom-thick planar sheets of sp²-bonded carbon atoms. In general, graphene films are densely packed in a honeycomb-like crystal lattice. See, e.g., the graphene film in FIG. 1C. A person of ordinary skill in the art can also envision that various graphene films may be used in the transparent electrodes of the present invention.

For instance, in some embodiments, the graphene film is in a pristine form. In other embodiments, the graphene film may be associated with one or more surfactants or polymers. In further embodiments, the graphene film may be doped with various additives. In some embodiments, the additives may be one or more heteroatoms of B, N, O, Al, Au, P, Si or S. In more specific embodiments, the doped additives may include, without limitation, melamine, carboranes, aminoboranes, phosphines, aluminum hydroxides, silanes, polysilanes, polysiloxanes, sulfides, thiols, and combinations thereof. In more specific embodiments, the graphene films may be HNO₃ doped and/or AuCl₃ doped.

In some embodiments, graphene films in transparent electrodes only consist of one layer (i.e., a monolayer). In other embodiments, the graphene films consist of multiple layers (e.g., 2-9 layers or more, but multiple layers may affect transparency).

Additional aspects of graphene films are disclosed in Applicants' co-pending PCT Application entitled “Growth of Graphene Films from Non-gaseous Carbon Sources.” This application is being concurrently filed with the present application and is incorporated herein by reference.

In additional embodiments of the present invention, graphene films may be made of sprayed graphene particles. Examples of such sprayed graphene particles are disclosed in Zhu et al., “High Throughput Preparation of Large Area Transparent Electrodes Using Non-Functionalized Graphene Nanoribbons,” Chem. Mater. 2011, 23, 935-939. As discussed in more detail below, such sprayed graphene particles can be in the form of graphene nanoribbons that were derived from carbon nanotubes. See, e.g., Zhu et al. (above) and Higginbotham et al., “Low-Defect Graphene Oxide Nanoribbons from Multiwalled Carbon Nanotubes,” ACS Nano 2010, 4, 2059-2069. Also see Applicants' co-pending U.S. patent application Ser. No. 12/544,057 entitled “Methods for Preparation of Graphene Nanoribbons From Carbon Nanotubes and Compositions, Thin Films and Devices Derived Therefrom.” In further embodiments, the sprayed graphene particles can be derived from exfoliated graphite, graphene nanoflakes, split carbon nanotubes, or reduced graphene oxide.

In additional embodiments, the sprayed graphene particles may cover an entire surface area of a transparent electrode in a uniform manner, such as by the formation of an interlinked network. In additional embodiments, the graphene particles may be scattered throughout a surface area of a transparent electrode to form a non-uniform graphene film. In additional embodiments, the covered surface area can be a top surface of a substrate, a top surface of a grid structure, or other surfaces on transparent electrodes. Methods of obtaining graphene films in accordance with the aforementioned embodiments will be discussed in more detail below.

Substrates

In the present invention, substrates generally refer to support structures for the transparent electrodes of the present invention. A person of ordinary skill in the art will also recognize that various substrates may be used with the transparent electrodes of the present invention. Non-limiting examples of suitable substrates include glass, quartz, boron nitride, silicon, plastic, polymers (e.g., PET) and combinations thereof.

Desirably, the substrates of the present invention are also transparent in order to maintain the transparency of the transparent electrodes. For instance, in a specific embodiment, the substrate is glass. In another specific embodiment, the substrate is PET. Other suitable substrates can also be envisioned by persons of ordinary skill in the art.

A person of ordinary skill in the art will also recognize that the substrates of the present invention can have various shapes and properties. See, e.g, FIGS. 1A-1E. For instance, in some embodiments, the substrate has a non-planar shape. In additional embodiments, the substrate has a planar shape. In further embodiments, the substrate is flexible at room temperature. In additional embodiments, the substrate is rigid.

Transparent Electrode Arrangements

A person of ordinary skill in the art will also recognize that the transparent electrodes of the present invention can have different arrangements. For instance, in some embodiments, the graphene film is positioned on a top surface of a grid structure. In more specific embodiments, the grid structure may also be positioned on a top surface of a substrate. FIG. 1A depicts the aforementioned “graphene topped” arrangement in transparent electrode 10. In this example, grid structure 14 is on a top surface of substrate 16, and graphene film 12 is on a top surface of grid structure 14. In addition, FIG. 1C depicts a more specific example of this “graphene topped” structure, where the grid structure is a metal grid and the substrate is glass.

In another embodiment, the grid structure may be positioned on a top surface of a graphene film. In more specific embodiments, the graphene film may also be positioned on a top surface of a substrate. FIG. 1B depicts the aforementioned “grid topped” structure in transparent electrode 20. In this example, graphene film 22 is sandwiched between grid structure 24 and substrate 26.

In additional embodiments, the different components of the present invention may be adhesively associated with one another. As used herein, “adhesive association” generally refers to the association of the different components of transparent electrodes by various methods, including fusion, adhesion with a film such as polyurethane, and other forms of direct contact known to persons of ordinary skill in the art.

For instance, in some embodiments, the grid structure and the graphene film may be adhesively associated with each other. In other embodiments, a substrate may be adhesively associated with a grid structure. In more specific embodiments, the substrate may be adhesively associated with a grid structure, and the grid structure may be adhesively associated with a graphene film to form the above-mentioned “graphene topped” transparent electrodes in FIGS. 1A and 1C.

In additional embodiments, various adhesion layers may be used to adhesively associate the various components of transparent electrodes to the substrate or the graphene film. For instance, in some embodiments, the adhesion layer may include, without limitation, Cr, Ti and/or Ni. As discussed in more detail below, various methods may also be used to adhesively associate the different transparent electrode components with one another. Such methods sometimes comprise heating the transparent electrodes at high temperatures in the absence of oxygen.

A person of ordinary skill in the art can also recognize different arrangements and associations of transparent electrode components that were not discussed here. As discussed in more detail below, the above-mentioned structural variations of transparent electrodes provide different advantages and applications.

Methods of Making Transparent Electrodes

Additional embodiments of the present invention involve methods of making the above-described transparent electrodes. Such methods generally include: (1) providing a grid structure; (2) providing a graphene film; and (3) associating the graphene film with the grid structure. In additional embodiments, the methods of the present invention may also include associating transparent electrodes with (4) a substrate. In some of such embodiments, the methods may include (a) positioning the grid structure on a top surface of the substrate; and (b) positioning the graphene film on a top surface of the grid structure to form the previously described “graphene topped” transparent electrodes. See FIGS. 1A and 1C.

Furthermore, the above-mentioned methods may also include an annealing step that adhesively associates the various components of the transparent electrodes to each other. For instance, in some embodiments, the annealing step may include the addition of an adhesion layer to one of the components, as previously described (e.g., addition of an adhesion layer between the substrate and the grid structure). In other embodiments, the annealing step may include the heat treatment of the transparent electrode. In some embodiments, the heat treatment occurs in the absence of oxygen. In more specific embodiments, the heat treatment includes the treatment of the transparent electrode structure in an H₂/Ar purged furnace for 30 minutes at about 350° C.

A person of ordinary skill in the art will also recognize that various methods may be used to form graphene films and grid structures for use in the transparent electrodes of the present invention. Such methods will now be described in more detail below.

Grid Structure Formation

Various methods well known to persons of ordinary skill in the art can be used to form or provide grid structures. For instance, in some embodiments, grid structures are formed or provided by methods such as evaporation, sputtering, chemical vapor deposition (CVD), inkjet printing, gravure printing, painting, photolithography, electron-beam lithography, soft lithography, stamping, embossing, patterning, and combinations thereof.

In more specific embodiments, a grid structure may be prepared on a transparent substrate (typically glass) by photolithography, inkjet printing, gravure printing or some other patterning technique. To produce a high resolution metal grid in some embodiments, photolithography with an etching procedure can be utilized. Likewise, if carbon-based materials are being utilized as grid structures in some embodiments, CVD or sputtering techniques may be utilized along with a masking technique. Other methods of forming grid structures can also be envisioned by persons of ordinary skill in the art.

Graphene Film Formation

A person of ordinary skill in the art will also recognize that various methods may be used to form or provide graphene films for incorporation into the transparent electrodes of the present invention. Such methods can include, without limitation, CVD-based growth, growth of a carbon source on a catalyst surface (e.g., polymer-based growth on a metal surface), reduction of graphene oxide, splitting of carbon nanotubes, spraying of graphene particles or precursors (e.g., graphene oxide), exfoliation of graphite, mechanical peeling, and combinations thereof.

In more specific embodiments, the graphene film is formed or provided by the spraying of graphene particles. In some embodiments, the graphene particles may be sprayed onto a top surface of a grid structure. In additional embodiments, the graphene particles may be sprayed onto a top surface of a substrate.

In various embodiments, the graphene particles to be sprayed can include, without limitation, graphene nanoflakes, graphene nanoribbons, exfoliated graphite, reduced graphene oxide, split carbon nanotubes, and combinations thereof.

The graphene particles to be sprayed can be dissolved in various solvents. Examples of such solvents include, without limitation, 1,2-dichlorobenzene, dimethylformamide, chlorobenzene and toluene. In additional embodiments, the solvent may primarily consist of water and a surfactant. After the spraying, the surfactant can be removed by rinsing the sprayed surface with water or alcohol (e.g., methanol, ethanol, isopropanol, and combinations thereof).

In additional embodiments, graphene films can be formed or provided by the spraying of one or more graphene precursors. Such precursors can include, without limitation, graphene oxide nanoribbons, graphene oxide nanoflakes, and combinations thereof. The graphene precursors may also be sprayed onto a top surface of a grid structure, or a top surface of a substrate in some embodiments.

The spraying of the graphene precursors onto a surface is typically followed by a reduction step to convert the graphene precursors to graphene. In some embodiments, the reduction step can include, without limitation, treatment with heat or treatment with a reducing agent (e.g., hydrazine, sodium borohydride, and the like). In various embodiments, heat treatment may occur in an atmosphere that is under a stream of one or more gases, such as N₂, Ar, H₂ and combinations thereof.

In additional embodiments, graphene films can be formed or provided by the splitting of carbon nanotubes onto a surface. In some embodiments, carbon nanotubes are split by using potassium metal to form nanoribbons. See, e.g., Kosynkin et al., “Highly Conductive Graphene Nanoribbons by Longitudinal Splitting of Carbon Nanotubes Using Potassium Vapor,” ACS Nano 2011, 5, 968-974. Also see Applicants' co-pending U.S. patent application Ser. No. 12/544,057 entitled “Methods for Preparation of Graphene Nanoribbons From Carbon Nanotubes and Compositions, Thin Films and Devices Derived Therefrom.” Since such methods usually form oxidized forms of graphene, the methods are also typically followed by a reduction step (as described).

In more specific embodiments, graphene films may be formed or provided by unzipping carbon nanotubes via longitudinal oxidation, followed by reduction if desiring more conductive ribbons, or by splitting carbon nanotubes using potassium metal to form nanoribbons. See, e.g., Kosynkin et al., “Highly Conductive Graphene Nanoribbons by Longitudinal Splitting of Carbon Nanotubes Using Potassium Vapor,” ACS Nano 2011, 5, 968-974. Examples of such methods are disclosed in U.S. patent application Ser. No. 12/544,017, the entirety of which is incorporated herein by reference. Additional examples are included in Applicants' co-pending U.S. patent application Ser. No. 12/544,057 entitled “Methods for Preparation of Graphene Nanoribbons From Carbon Nanotubes and Compositions, Thin Films and Devices Derived Therefrom.” In these cases, the nanoribbons can be applied as a spray to the substrate or atop the grid. This can further be done with graphene sheets (see former references and disclosure).

In more specific embodiments, graphene films may be obtained by annealing a carbon source, such as polymethyl methacrylate (PMMA), on a metal catalyst, such as a copper foil. In other embodiments, graphene films may be formed or provided by CVD-based growth on suitable metals (e.g., Ni or Cu). Thereafter, the formed graphene films may be transferred to the metal grid-patterned transparent substrate directly. In additional embodiments, carbon sources that form graphene films may be doped with a doping reagent, such as a heteratom (e.g., BH₃).

Additional aspects of graphene film formation methods are disclosed in Applicants' co-pending PCT Application entitled “Growth of Graphene Films from Non-gaseous Carbon Sources.” This application is being concurrently filed with the present application and is incorporated herein by reference.

Exemplary Methods of Making Transparent Electrodes

As indicated above, numerous methods can be utilized to form the transparent electrodes of the present invention. Reference will now be made to specific and non-limiting examples.

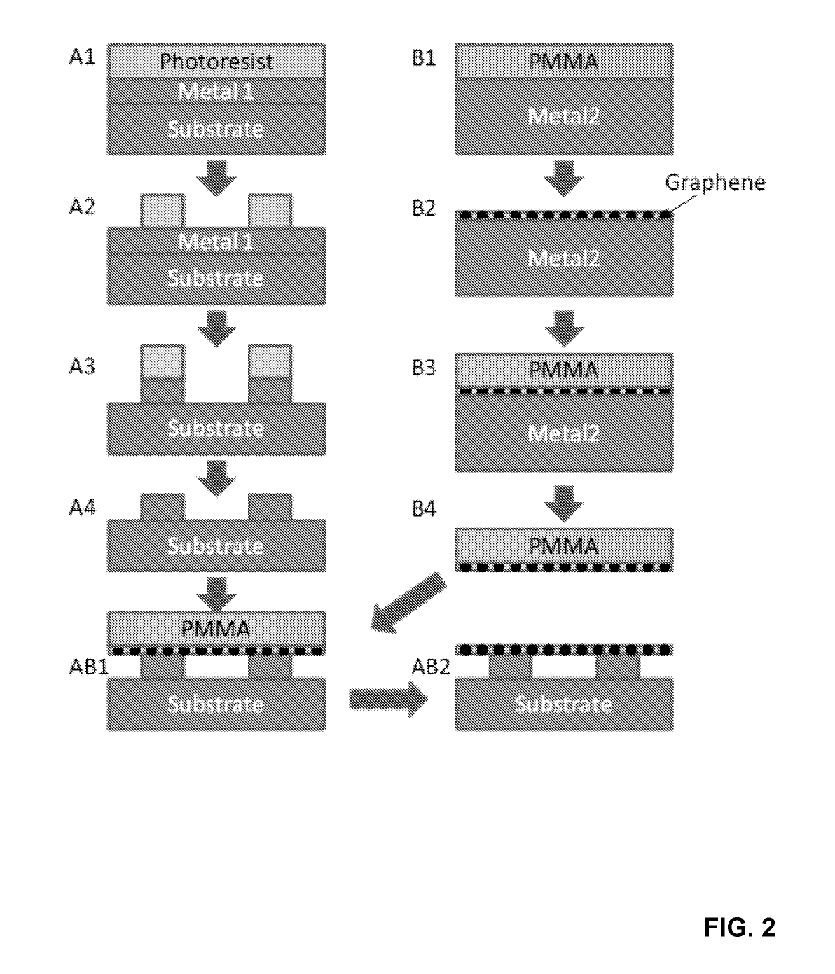

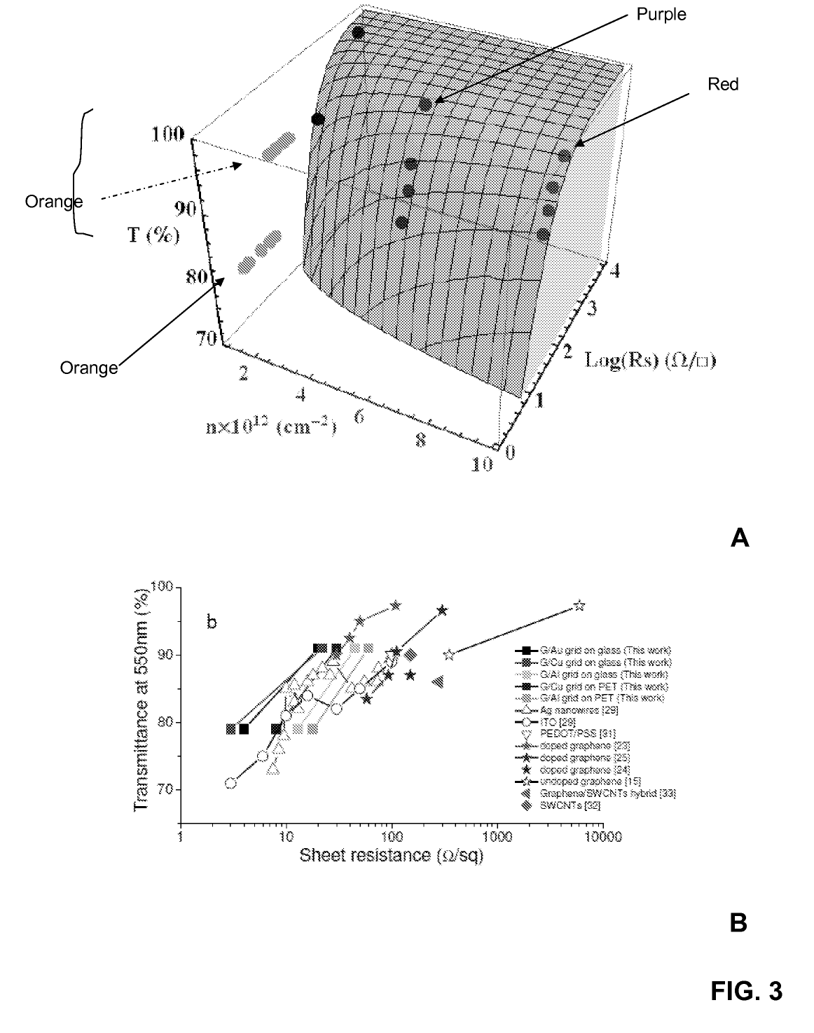

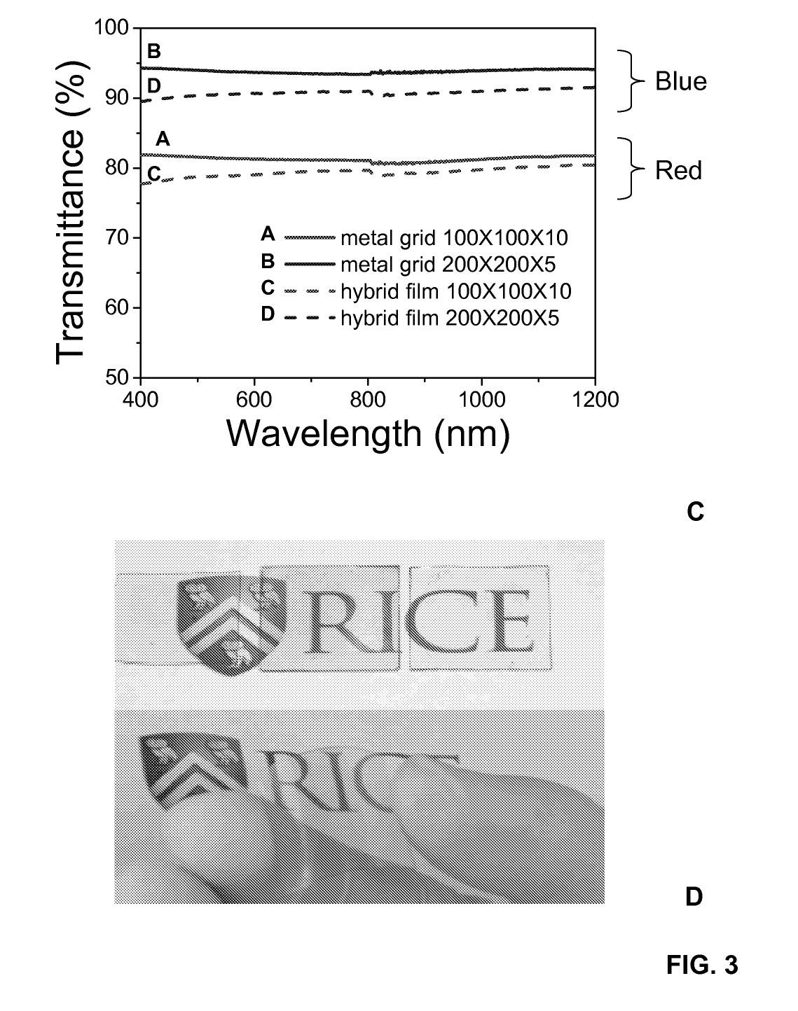

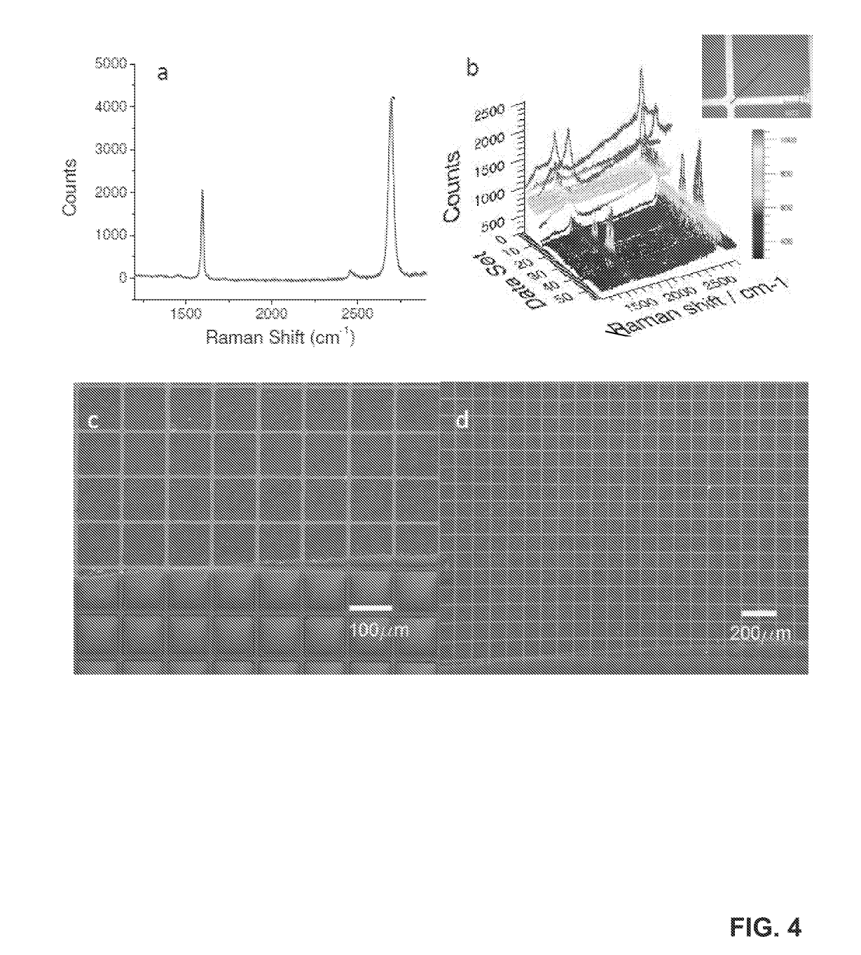

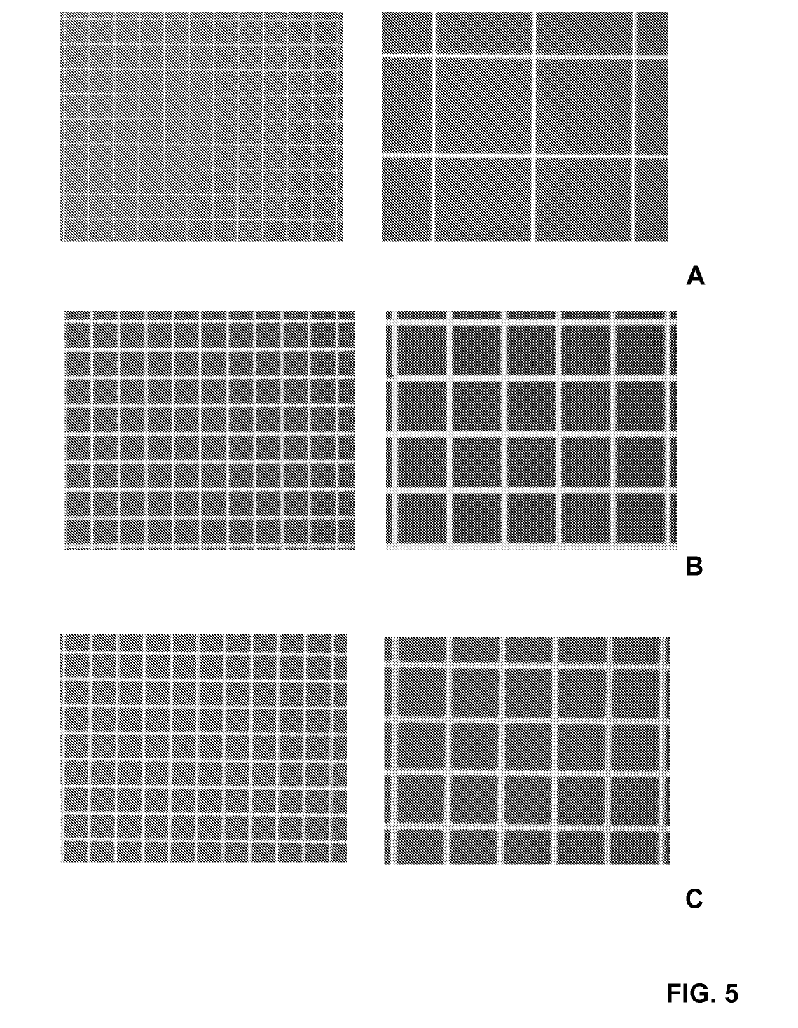

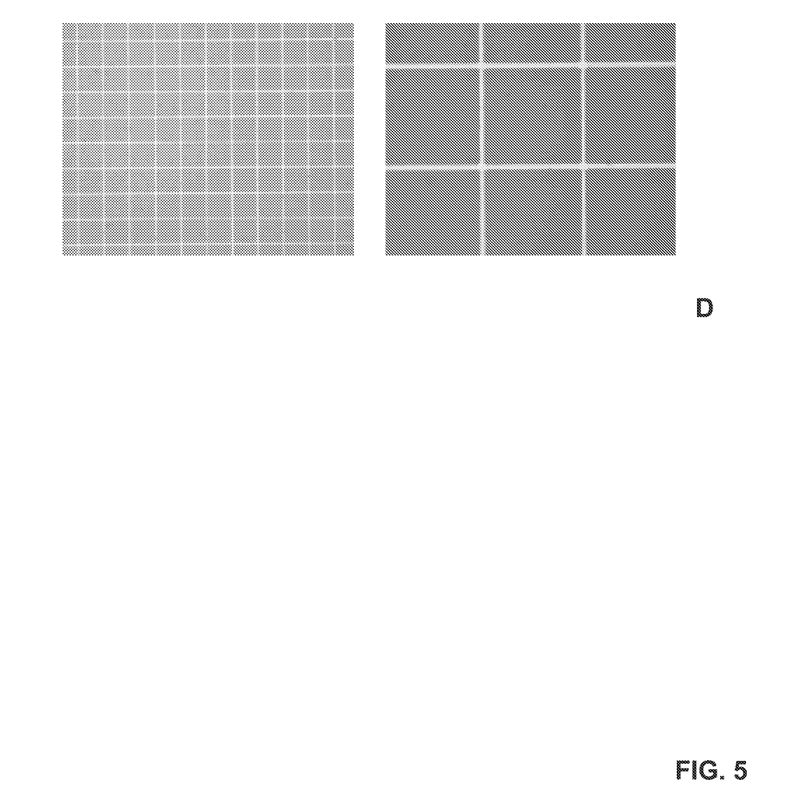

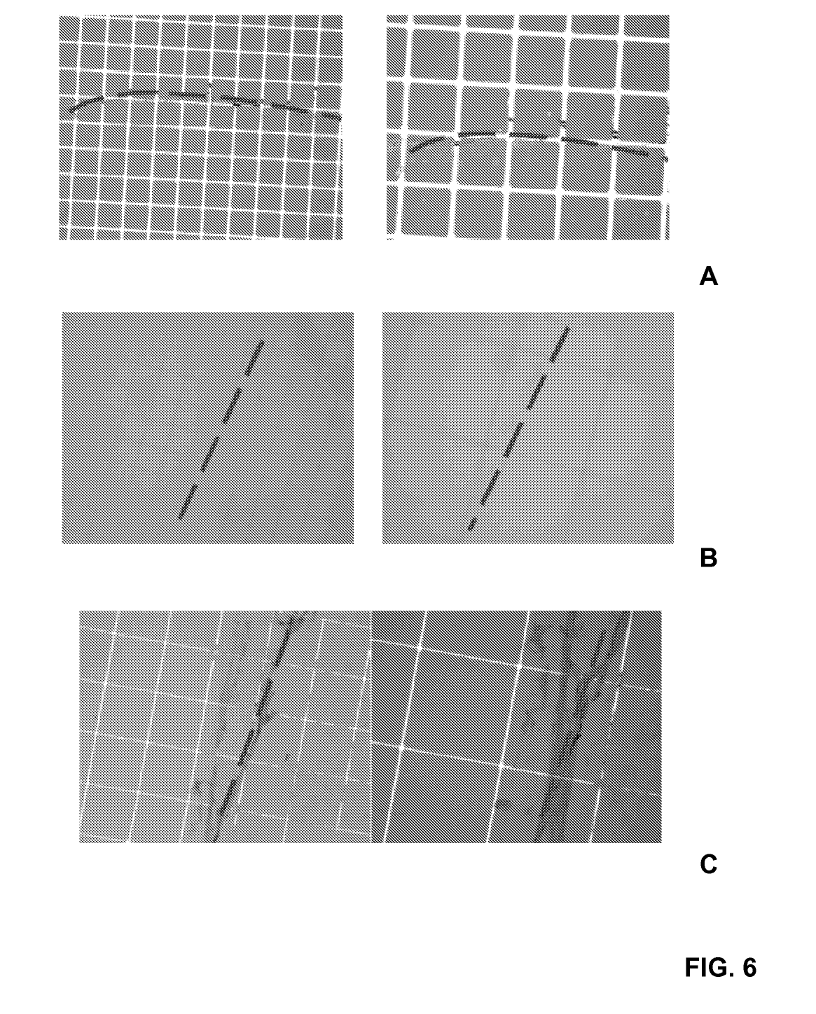

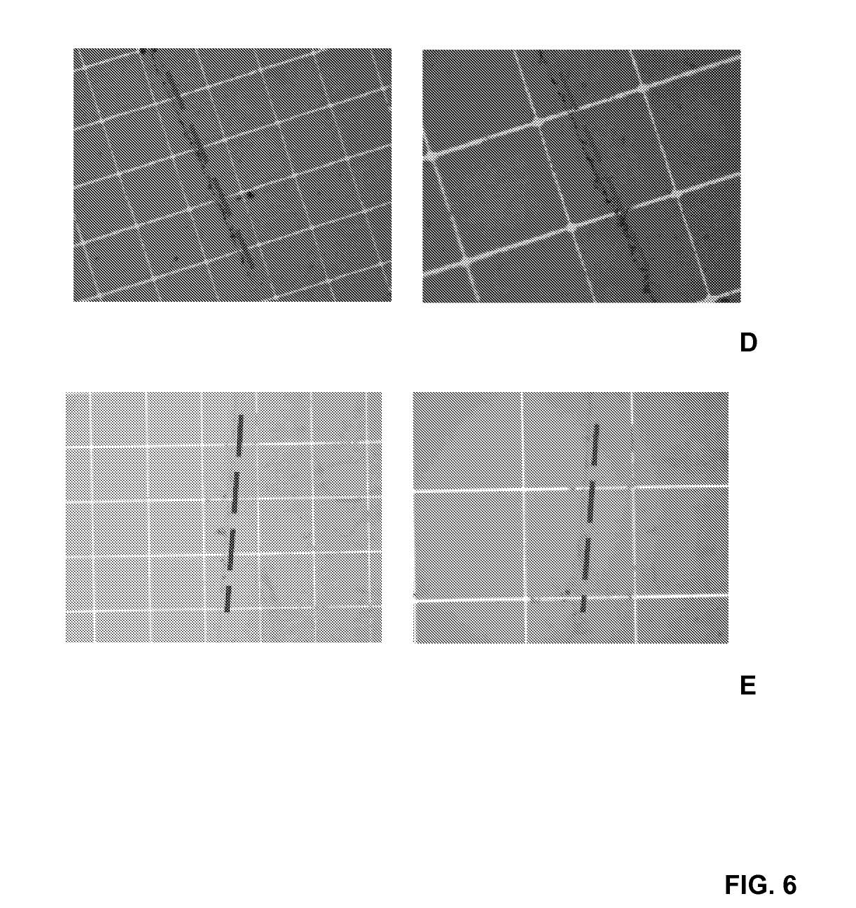

Formation of a “Graphene Topped” Transparent Electrode (e.g., FIGS. 1A and 2)

In this example, the grid structure is first prepared on a substrate (e.g., glass) by photolithography, inkjet printing, gravure printing or some other patterning technique. To produce a high resolution metallic grid structure, photolithography with an etching procedure is conducted in some embodiments. If a carbon material is being used as a grid structure, CVD, sputtering with masking, inkjet printing or gravure printing may be used in some embodiments. An adhesion layer (e.g., Cr, Ti or Ni) may also be used if necessary to improve binding of the grid to the substrate. Thereafter, a graphene layer may be transferred to or deposited on top of the formed structure.

The advantages of forming a “graphene topped” structure can include: (1) reducing the possibility of etching graphene when the grid structure is etched; and (2) an easier way to get a large area grid structure.

A more specific example of a method of forming a “graphene topped” structure is depicted in FIG. 2. In this example, the grid structure is a metal grid. The substrate is a transparent glass substrate.

Specifically, schemes A1-A4 depict the preparation of the metal grid on the transparent glass substrate. In particular A1 represents the deposition of metal film (Metal 1) and photoresist on the glass substrate. Desirably, the glass surface is first cleaned with acetone and deionized water. Next, 3 nm titanium (as an adhesion layer) and 50 nm gold are sputtered or evaporated (thermal or e-beam) on the cleaned glass surface. Photoresist is then spin-coated on the gold surface.

Next, as depicted in A2-A4, the photoresist is patterned by photolithography. Specifically, gold and titanium are etched away by wet etching to form the metal grid pattern shown in A3. The residual photoresist is then washed away with acetone to form the structure in A4. In addition, the metal grid substrate is rinsed with de-ionized water.

Schemes B1-B4 depict the preparation of the graphene film by using a solid carbon source, such as PMMA. In particular, B1 depicts spin-coating PMMA on a copper foil (Metal 2). As depicted in B2, this is followed by the growth of the graphene film on a solid carbon source. Next, as shown in B3, a PMMA sacrificial layer is spin coated on a graphene. Likewise, B4 depicts wet etching of the copper foil to remove the graphene film from the metal substrate.

Finally, schemes AB1-AB2 depict the assembly of the transparent electrode. In particular, AB1 depicts the transferring of the graphene film onto the metal grid structure. Likewise, AB2 depicts the removal of the PMMA sacrificial layer by dissolution in a solvent, such as acetone.

Formation of “Grid Topped” Structure (e.g., FIG. 1B)

In this example, the graphene film may first be transferred to or deposited on a substrate. The grid structure may then be patterned on top of the graphene film by photolithography, inkjet printing, or other method as described above. In some embodiments, the “grid topped” structure may be suitable for robust transparent conducting films.

Advantages

A person of ordinary skill in the art will also recognize that the transparent electrodes of the present invention provide many advantages. Such advantages can include, without limitation: (1) low sheet resistance; (2) high transparency; (3) low costs; (4) availability of large fabrication areas; and (5) flexibility.

Low Sheet Resistance

In some embodiments, the sheet resistance of the transparent electrodes of the present invention (depending on the transmittance of the film) can be less than about 500 Ω/sq, less than about 100 Ω/sq, or less than about 30 Ω/sq. In more specific embodiments, the sheet resistance of the transparent electrode structures can be as low as about 25 Ω/sq to about 3 Ω/sq when the transmittance is not lower than 91% and 79% at 550 nm, respectively. See, e.g., FIG. 3C.

High Transparency

The transparent electrodes of the present invention can have transparencies of more than about 70%. In some embodiments, the transparency can be up to 97.7%. In more specific embodiments, the transparency is substantially in the visible region between about 400 and about 750 nm in wavelength, and more particularly around 550 nm. In more specific embodiments, the transparency is not lower than about 70% at 550 nm, not lower than about 80% at 550 nm, or not lower than about 90% at 550 nm.

Low Costs

The methods of making the transparent electrodes of the present invention are also cost effective. In particular, the materials used for the new transparent electrodes are earth-abundant stable elements, which increase their potential usefulness for replacement of indium-tin-oxide (ITO) in many applications. For instance, metal grids may be formed by normal photolithography techniques or by inkjet printing the precursor solution. In addition to the noble metals Au, Pt and Ag, more economically favored metals like Cu, Al and Ni can also be used.

Availability of Large Fabrication Areas

The methods of the present invention can be easily scaled up to provide larger transparent electrodes. For instance, conventional photolithography can easily be applied on substrates as large as several inches. Likewise, inkjet printing provides the possibility to process transparent electrodes on meter-sized substrates. Furthermore, even though graphene films may be limited to centimeter sizes, the formation of films can also be readily scaled up by using large annealing furnaces. And when applied by spray coating from graphene nanoribbons or graphene pieces, scalability could be even more simple.

Flexibility

The transparent electrodes of the present invention also display enhanced flexibility. Without being bound by theory, it is envisioned that graphene films used in the transparent electrodes renders the electrodes flexible. Such flexibility can be important for many applications that are disclosed below.

Applications

A person of ordinary skill in the art can also envision that the transparent electrodes of the present invention will find many applications. For instance, in some embodiments, the transparent electrodes of the present invention can be used as electrodes for optoelectronics applications, such as organic photovoltaics, organic light emitting devices, “smart window” panes, liquid crystal display devices, touch screens, and “head-up” displays in, for example, windscreens, goggles, glasses and visors. In more specific embodiments, the transparent electrodes of the present invention may find application in flexible solar cells and organic light emitting diodes (OLEDs).

### Additional Embodiments

From the above disclosure, a person of ordinary skill in the art will recognize that the methods and systems of the present disclosure can have numerous additional embodiments. Reference will now be made to more specific embodiments of the present disclosure and experimental results that provide support for such embodiments. However, Applicants note that the disclosure below is for exemplary purposes only and is not intended to limit the scope of the claimed invention in any way.

### EXAMPLES

Additional details about the experimental aspects of the above-described studies are discussed in the subsections below. In the Examples below, transparent, flexible conducting films were fabricated by using a metallic grid and graphene hybrid film. Transparent electrodes using the hybrid film and transparent substrate such as glass or PET films were assembled. The sheet resistance of the fabricated transparent electrodes was as low as 3 Ω/sq with a transmittance of ˜80%. At 90% transmittance, the sheet resistance was ˜20 Ω/sq. Both values are among the highest for transparent electrode materials to date. The materials used for the new hybrid electrode are earth-abundant stable elements, which increase their potential usefulness for replacement of indium-tin-oxide (ITO) in many applications.

By way of background, transparent conducting films have been widely used in applications such as solar cells, light-emitting devices, and electronic touch screens. In addition, graphene is a promising material for transparent electrodes. Monolayer graphene absorbs only 2.3% of visible light, rendering it one of the most transparent conductors available. Experimental results have demonstrated that graphene has a 230,000 cm²V⁻¹s⁻¹ electron mobility. The resistivity of pristine graphene has been estimated to be as low as 10⁻⁶ Ω·cm, which is a lower resistivity than silver. Generally, the sheet resistance, Rₛ, is used to describe the electric conductivity of a two dimensional transparent electrode. Rₛ has the following relationship to the mobility of materials (Eq. 1).

Rₛ=t/(qnₘμₘ) (1)

where nₘ and μₘ are the majority carrier density and mobility respectively, q is the unit charge and t is the thickness. Based on the experimental mobility data, monolayer graphene with a transmittance (T) of 97.7% will have a theoretical minimum sheet resistance of ˜30 Ω/sq at a carrier density of 10¹² cm⁻². This predicted value is better than the present commercial transparent conducting material ITO with sheet resistance of typically ˜30-80 Ω/sq when transmittance is about 90%.

However, graphene's extremely high mobility has only experimentally been observed on suspended graphene that is produced from mechanical exfoliation of highly ordered pyrolytic graphite (HOPG). Other scalable graphene-producing methods such as epitaxially grown graphene on silicon carbide and chemical vapor deposited graphene on metals such as Ni and Cu, produce lower quality graphene. The highest mobility of synthesized graphene used in a large area transparent electrode is 5100 cm² V⁻¹ s⁻¹ at room temperature, roughly 100 times less than the highest reported mobility of mechanically exfoliated graphene. Therefore, the typical experimental sheet resistance of synthesized graphene is between 2 k Ω/sq to 5 k Ω/sq (also roughly 100 times larger than the theoretical minimum). For practical usage in transparent electrodes, a transmittance approximately 90% is required. This permits the assembly of up to four layers of graphene to reduce the sheet resistance while maintaining 90% transparency. However, the sheet resistance of four-layered graphene is ˜350 Ω/sq, thereby falling 10-fold short of the desired sheet resistance of monolayered graphene.

Since the mobility of the graphene is limited by the scalable production process, increasing the carrier density becomes an alternative method for reducing the sheet resistance of graphene. Various doping methods have been suggested to make the graphene more conductive. As early as 2008, Novosolov et al. demonstrated poly vinyl alcohol (PVA)-coated graphene exhibiting a sheet resistance of 450 Ω/sq due to the doping effect of PVA. Systematic studies have been reported recently for doped graphene-based transparent electrodes. Bae et al. demonstrated that monolayer graphene doped by nitric acid exhibits a sheet resistance as low as 125 Ω/sq (T=97%), and the same four-layered graphene transparent electrode was reported with a sheet resistance of 30 Ω/sq (T=90%). Kim et al. reported AuCl₃-doped graphene, which has a minimum sheet resistance of 150 Ω/sq (T=87%). Güne [symbol] et al. proposed a method of layer-by-layer (LbL) doping of thin graphene films, which can reach a sheet resistance of 54 Ω/sq (T=85%). In that work, graphene formed ion pairs with the dopant molecules. Although the performance of the transparent films produced using doped graphene have been similar to the performance of ITO, the stability of the graphene-dopant system is unknown. Similar doping effects have been studied in SWCNTs films, and the doping enhancements had limited stability in air and under thermal loading. Considering that a major application for transparent electrodes is in solar cells where the commercial products lifetime is 25-30 years and LED lamps with expected lifetimes being similar, it is necessary to improve the graphene-based transparent electrode.

The practical limitations of the conventional methods for making graphene-based transparent electrodes can be overcome by assembling the transparent electrode in a way other than only using transparent materials. Instead, transparent electrodes can also be made using a non-transparent material such as metal nanowires or carbon nanotubes. Unlike transparent ITO, poly(3,4-ethylenedioxythiophene)/poly(styrenesulfonate) (PEDOT/PSS) and graphene, those materials themselves are opaque. However, the materials can form thin transparent percolation networks. The network can conduct current and leave large empty spaces that render these films transparent. Based on the understanding of these two approaches for making transparent conducting film, in this Example Applicants disclose a graphene hybrid structure to reduce the sheet resistance of these synthetic graphene based transparent electrodes, and even exceed the theoretical limit of a graphene film. The idea is to use a non-transparent, highly conductive metal to make the grid structure. Monolayer graphene or few-layer graphene or spray-on networks are then transferred on top of the grid to fill the uncovered area. See FIG. 1C.

The integration of the metal grid has many advantages. First, unlike graphene, which is a two dimensional material, metal is a three dimensional material. Although the resistivity of metal is higher than that of graphene, it can have a smaller sheet resistance than monolayer graphene by using a thick film. Based on the definition of sheet resistance set forth in Eq. 2 below,

R=(ρ/t)(L/W)=Rₛ(L/W) (2)

(where Rₛ=sheet resistance, ρ=resistivity, R=resistance, t=thickness, W=width, L=length), a 100-nm silver film will have a sheet resistance of 0.16 Ω/sq. This resistance is about 200 times smaller than the limited sheet resistance of graphene.

Secondly, the graphene grown on copper or nickel substrates have inevitable defects induced by metal grain boundaries and the transferring techniques. For example, it is known that the grain size of crystalline copper is typically over 100 μm. In addition, defects have been found on the grain boundaries, which could be one reason for the high sheet resistance of synthesized graphene films. See FIGS. 1G-1H. By using a suitable grid size (˜100 μm), the effects of those defects can be reduced. Last, since monolayer graphene is almost transparent (it absorbs only 2.3% visible light per graphene layer), the transmittance of the hybrid film can be easily adjusted by modulating the metal grid size and gridline width.

The process sequence used in this work is depicted in FIG. 2 (as previously described in broader terms). First, the metal grids are formed on the transparent substrate. Then, a graphene film is grown on a copper foil and isolated with a layer of sacrificial PMMA. The graphene film is then transferred to the top of the grid, and the sacrificial PMMA layer is removed to form the final hybrid transparent electrodes. There are many ways to generate a metal grid structure on a transparent substrate. In this work, photolithography with wet-etching was applied to produce the metal grid structure. This procedure has numerous advantages. First, photolithography is a high throughput method with which large substrates can be easily processed. Second, the metal grid networks formed by photolithography have minimal contact resistance between grid-lines. For instance, in randomly formed metal nanowire or carbon nanotube networks, the contact resistances are generally much larger than that of the single wire or tube, which make those films more resistive than expected. Furthermore, wet-etching is preferred over lift-off techniques since the former procedure has better yields on large devices. Other more cost-effective techniques, such as inkjet printing of the metal nanowire or nanoparticle solution, are available for making the metal grid structure needed.

The graphene film was grown on copper either by using a gas carbon source or solid carbon source. The sheet resistance of the hybrid transparent electrode was measured by an Alessi four-point probe. The reported values are based on an average of 20 measurements for each sample. The transmittance was measured by a Shimadzu UV-vis-NIR Spectrometer. The results are shown in Table 1.

TABLE 1
Sheet Resistance and Transmittance of Graphene/Metal Grid Hybrid Films, Entries 1-10. The metal
films on glass substrate were prepared by sputtering. The metal films on PET substrate were
prepared by thermal evaporation. When gold was used as the metal grid material, a thin layer
of titanium (5 nm) was used as adhesion layer. When copper was used as the metal grid material,
a thin layer of aluminum (5 nm) was used as the adhesion layer. The thickness of the metal layer
was 100 nm in all cases. The best results from published alternative
transparent conducting electrode materials are in entries 11-19.

| | | | Grid line | | Sheet resistance |
|---|---|---|---|---|---|
| Entry | Name | Grid size | width | Metal/Substrate | (Transmittance)* |
| 1 | Hybrid | 100 μm × 100 μm | 10 μm | Au/Glass | 4 Ω/sq (79%) |
| 2 | transparent conducting | 200 μm × 200 μm | 5 μm | Au/Glass | 20 Ω/sq (91%) |
| 3 | electrode | 100 μm × 100 μm | 10 μm | Al/Glass | 13 Ω/sq (79%) |
| 4 | | 200 μm × 200 μm | 5 μm | Al/Glass | 45 Ω/sq (91%) |
| 5 | | 100 μm × 100 μm | 10 μm | Cu/Glass | 3 Ω/sq (79%) |
| 6 | | 200 μm × 200 μm | 5 μm | Cu/Glass | 22 Ω/sq (91%) |
| 7 | | 100 μm × 100 μm | 10 μm | Al/PET | 18 Ω/sq (79%) |
| 8 | | 200 μm × 200 μm | 5 μm | Al/PET | 60 Ω/sq (91%) |
| 9 | | 100 μm × 100 μm | 10 μm | Cu/PET | 8 Ω/sq (79%) |
| 10 | | 200 μm × 200 μm | 5 μm | Cu/PET | 30 Ω/sq (91%) |
| 11 | ITO | | | Glass | 30-80 Ω/sq (90%) |
| 12 | PEDOT/PSS | | | Glass/PET | 100 Ω/sq |
| | | | | | (with 5% |
| | | | | | DMSO) (90%) |
| 13 | SWCNTs | | | Glass | 150 Ω/sq (90%) |
| 14 | Graphene | | | Glass | 350 Ω/sq (90%) |
| 15 | Graphene/ | | | Glass | 280 Ω/sq (86%) |
| | SWCNTs | | | | |
| 16 | Silver nanowires | | | PET | 110 Ω/sq (90%) |
| 17 | Graphene | | | Glass | 150 Ω/sq (87%) |
| | (doped by AuCl₃) | | | | |
| 18 | Graphene | | | PET | 54 Ω/sq (85%) |
| | (doped by AuCl₃) | | | | |
| 19 | Graphene | | | PET | 30 Ω/sq (90%) |
| | (doped by HNO₃) | | | | |

*Transmission of hybrid film at 550 nm, excluding substrate absorption which was subtracted using a blank substrate.

As indicated by the results summarized in Table 1, the graphene/metal grid hybrid transparent electrode can match or outperform all reported transparent electrode materials. The sheet resistance of the hybrid film was as low as 20 Ω/sq with transmittance over 90%. At lower transmittance (˜80%), the sheet resistance can reach 3 Ω/sq.

To evaluate the performance of transparent conducting electrode, it is necessary to consider both sheet resistance and transmittance. Unfortunately, literature sheet resistance data is often taken under different transmittance values, making direct comparisons difficult. Recently, a theoretical model for few-layer graphene has been proposed, which gives the relationship between transmittance and sheet resistance. Based on the model of few-layered graphene, the transmittance and sheet resistance of graphene can be expressed by the following equation:

$$T = {( 1 + \text{?} )}^{- 2} \\ \text{?} \text{indicates text missing or illegible when filed} \qquad ( 3 )$$

(where Z₀=1/ε₀c=377Ω is the free-space impedance, ε₀ is the free-space electric constant and c is the speed of light, and G₀=e²/(4 h)≈6.08×10⁻³Ω⁻¹ the optical conductivity).

In graphene, the bidimensional d.c. conductivity is σ_{w}=npe, where n is the number of charge carriers and μ is the mobility. In general semiconductors, the mobility drops when the charge carrier density increases. However, experimental results show that the mobility of graphene is not affected by chemically induced ionized impurities in the graphene in concentrations as high as 10¹² cm⁻² (where the dopants are less than 10 nm apart) until it reaches values of ˜10⁵ cm²·V⁻¹·s⁻¹. At higher carrier concentration, the mobility of graphene can be affected. For example, when the carrier density reaches 10¹³ cm⁻², the experimental observed mobility of graphene is between 2000 and 10000 cm²·V⁻¹·s⁻¹. As long as the graphene transparent electrodes are made by a scalable method such as chemical vapor deposition, they can reach mobilities of 4000-5000 cm²·V⁻¹·s⁻¹ at room temperature when placed on an insulating substrate. Applicants assume that chemical doping will not change this mobility when the carrier density is smaller than 10¹³ cm⁻².

Based on Eq. 3 above, the sheet resistance and transmittance of graphene are plotted in FIG. 3A. The mesh surface in FIG. 3A could be regarded as the limitation of the present graphene transparent electrode (according to the mobility of 5000 cm² V¹ s¹). In addition, the shadowed region under the surface is achievable by present graphene transparent electrodes. The previously reported graphene transparent electrode data is plotted in FIG. 3A as well. The most heavily doped material results (red dots in FIG. 3A) approach the calculation limit. Other undoped (black dots in FIG. 3A) or doped graphene (purple dots in FIG. 3A) show sheet resistance larger than the theoretical limit at the same transmittance (in the shadow region). In the hybrid electrode of this work, the graphene is not doped. Hence, we assume that they have similar carrier densities to pristine graphene, which is <10¹² cm⁻² at room temperature. It is clear that all hybrid electrode results in this work (orange dots in FIG. 3A) outperformed the theoretical limit of present graphene (surface in FIG. 3A). Considering the graphene used in this work have similar mobility as other reported scalable methods, the highly conductive metal network underneath should also contribute to the low sheet resistance recorded. The gold or copper grid based hybrid transparent electrode show better performance than all reported graphene transparent electrodes. The lower efficiency of the graphene aluminum grid electrode might originate from the surface oxide on the aluminum causing a higher contact resistance.

The results of this work are also compared in FIG. 3B with the other types of transparent electrode. It is clear that hybrid graphene transparent electrode is the best choice between the transmittance range of 70˜91%, which is enough for most transparent conducting electrode-based applications.

The broad absorbance spectra of the graphene/metal grid hybrid film are plotted in FIG. 3C. The transmittances of the hybrid film are almost flat in the range of 400-1200 nm, in contrast to ITO, which has a transmittance maximum at 550 nm. The additional graphene layer introduced the expected 2-3% loss of transmittance compared with the original metal grid frame. Furthermore, the hybrid film adapts to both rigid (glass) and flexible (PET) substrates, rendering it a general purpose transparent conducting electrode materials. See FIG. 3D

The graphene film used in this work was predominantly composed of a monolayer, as indicated by Raman spectroscopy. See FIG. 4A. When Raman spectra were taken directly from the hybrid electrode, the metal enhancement was observed where there was a metal line underneath. Full coverage of graphene on the grid structure was confirmed by Raman mapping (FIG. 4B) and SEM images (FIGS. 4C-4D). FIGS. 4C-4D show the edges of the graphene film, where the contrast between the graphene covered and non-covered grid is clear. More optical images are shown in FIGS. 5A-5D and 6A-6E.

Since no chemical doping was introduced to increase the carrier density of the graphene, the hybrid transparent electrodes are free of degradations originating from the dopant. The graphene/gold grid hybrid electrode was tested after exposure to ambient condition for 6 months and the sheet resistance was the same as the fresh sample (an indication of the stability of the electrode).

In summary, a new graphene/metal grid hybrid transparent electrode has been developed. Based on the available data, the transparent metal grid/graphene electrode outperformed all commercial and research-based transparent conducting films in the transmittance range of 70-91%. The hybrid film is stable under ambient temperature when a suitable metal is used. The hybrid film can also be integrated onto a flexible substrate, which renders this hybrid film a general purpose transparent electrode material.

Various experimental aspects of the above study will now be discussed in more detail in the Examples below.

### Example 1

### Formation of Grain Boundaries at the Edges of Graphenes

Applicants observed that grain boundaries are formed at the Cu foil domain edges of graphenes. See FIGS. 1F-1G. Applicants also observed that those boundaries have sizes of >100 μm after annealing the copper foil. These observations agree well with the observation reported in the literature.

The size of the Cu grain boundary is one of the guides to design the transparent electrode metal grid size. Starting from any point on the copper foil to travel 100-200 μm, at least one grain boundary will be met. It is likely that graphene grown on this Cu foil will have defects at the Cu grain boundaries. This means that when the graphene is transferred onto a substrate, the current applied to the graphene will cross a defect after travelling 100-200 μm. If the metal grid has a size of 100-200 μm, the chances of the current crossing the graphene defects will be much smaller because the metal grid can bridge the defects.

### Example 2

### Mask Preparation

The grid mask used in this work is made by DWL66 mask maker. As outlined in Table 2 below, the mask has the following parameters.

TABLE 2
Grid Mask Parameters.

| Abbreviation | | | Theoretical |
|---|---|---|---|
| in the text | Grid size | Grid line width | transmittance |
| 100 × 100 × 10 | 100 μm × 100 μm | 10 μm | 82.6% |
| 200 × 200 × 5 | 200 μm × 200 μm | 5 μm | 95.2% |

### Example 3

### Photolithography Patterning of Grids on Substrates

The compositions of the etchants used in this work are listed in Table 3 below.

TABLE 3
Metal etchants used.

| Metal | Etchant |
|---|---|
| gold | I₂ (5 g) + KI (10 g) + H₂O (85 g), 20° C. |
| titanium | H₂O (20 g) + H₂O₂ (30%, 1 g) + HF (48%, 1 g), 20° C. |
| copper | CuSO₄ (10 g) + HCl (37%, 50 mL) + H₂O (50 mL) |
| nickel | CuSO₄ (10 g) + HCl (37%, 50 mL) + H₂O (50 mL) |
| aluminum | H₃PO₄ (85%, 80 g) + HNO₃ (70%, 5 g) + HOAc |
| | (99%, 5 g) + H₂O (10 g), 70° C. |

Gold Metal Grid on Glass.

The glass substrates used in this work were Premiere® brand 9101 microscope slides. The glass slides were cut into 1 inch×1 inch square samples by a dicing saw. The square samples were cleaned in a fresh piranha solution (7:3 mixture of 98% H₂SO₄/30% H₂O₂) (Caution: The mixture is strongly oxidizing and may detonate upon contact with organic material). Next, the samples were rinsed with de-ionized water. The cleaned samples were sputtered with 5 nm Ti and 100 nm Au using a CrC-150 sputter coater. Photoresist (Shipley 1813) was spun onto the Au film (4000 rpm, 60 s). The samples were baked and then exposed using the prepared grid mask. After being developed by MICROPOSIT MF-319 developer (45 s), the films were baked again on a hot-plate (110 C) for 10 min. The second bake is important to obtain defect-free grid structures on the inch-sized samples. The samples were then etched by the Au etchant and then the Ti etchant. The residual photoresist was removed with hot acetone. Optical images of the Au grids are shown in FIGS. 1D-1E.

Copper Grid on Glass

The procedure for making the Cu grid is similar to the preparation of the Au grid. In order to prepare the Cu grid, 5 nm Ni and 100 nm Cu were evaporated on the substrate by using an Edwards 305 thermal evaporator. The film could be prepared using a sputter coater instead. Al was used as the adhesion layer instead of Ni. Optical images of the Cu grids are shown in FIG. 5A.

Aluminum Grid on Glass

The procedure for making the Al grid is the same as for the preparation of the Cu grid. However, due to the good adhesion of Al on glass, no adhesion layer was needed. The thickness of Al film was 100 nm. Optical images of the Al grids are shown in FIG. 5B.

Copper Grid on Poly(Ethylene Terephthalate) (PET)

The procedure is similar to the preparation of the Cu grid on glass except for the adhesion layer. Al was used as the adhesion layer when the PET substrate was used because Ni has a high melting point and the PET substrate overheated when attempting to deposit Ni with the Edwards evaporator. The thickness of the Cu film was 100 nm. Optical images of the Cu grids on PET are shown in FIG. 5C.

Aluminum Grid on PET

The procedure was the same as the preparation of Al grid on glass substrate. The thickness of aluminum film is 100 nm. Optical images of the Al grids on PET are shown in FIG. 5D.

### Example 4

### Transferring Graphene onto a Metal Grid

Graphene was grown using a recently developed low temperature growth technique with poly(methyl methacrylate) (PMMA) as the carbon source. In some cases, the standard CVD method was applied as well. The graphene used in this work had mobilities between 700-2000 cm² V₋₁ s₋₁. The wet transfer technique was used to transfer graphene onto the metal grid substrate. In brief, a thin layer of PMMA was spun on the graphene covered copper foil, and then the copper was etched with copper etchant. The floating PMMA passivated graphene was rinsed with water several times and transferred on various metal grid substrates. The sacrificial PMMA was finally removed with an acetone rinse at room temperature. The hybrid transparent electrode was dried in a vacuum oven overnight. The monolayer graphene film was almost invisible under the optical microscope. It is necessary to observe the edge of the graphene where the contrast between the covered and the uncovered areas are slightly different. The optical microscope images in FIG. 6 show the edges of the graphene on different metal grid substrates.

In sum, Applicants have invented highly transparent, low sheet resistance, flexible, substrate compatible, low cost, and robust transparent electrodes. The main properties of the devices are better than or comparable with those of more expensive, nonflexible ITO electrodes.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A transparent electrode comprising:
a. a grid structure; and
b. a graphene film associated with the grid structure.

2. The transparent electrode of claim 1, wherein the grid structure and the graphene film are adhesively associated with each other.

3. The transparent electrode of claim 1, wherein the graphene film is positioned on a top surface of the grid structure.

4. The transparent electrode of claim 1, wherein the grid structure is selected from the group consisting of metals, carbon nanotubes, graphite, amorphous carbons, metal particles, metal nanoparticles, metal microparticles, and combinations thereof.

5. The transparent electrode of claim 4, wherein the grid structure comprises one or more carbon nanotubes selected from the group consisting of single-walled carbon nanotubes, multi-walled carbon nanotubes, double-walled carbon nanotubes, ultrashort carbon nanotubes, and combinations thereof.

6. The transparent electrode of claim 4, wherein the grid structure comprises one or more metals selected from the group consisting of Au, Pt, Cu, Ag, Al, Ni, and combinations thereof.

7. The transparent electrode of claim 1, wherein the graphene film comprises pristine graphene.

8. The transparent electrode of claim 1, wherein the graphene film comprises doped graphene.

9. The transparent electrode of claim 8, wherein the doped graphene film comprises one or more heteroatoms selected from the group consisting of melamine, carboranes, aminoboranes, phosphines, aluminum hydroxides, silanes, polysilanes, polysiloxanes, sulfides, thiols, and combinations thereof.

10. The transparent electrode of claim 1, wherein the graphene film comprises sprayed graphene particles, wherein the sprayed graphene particles are selected from the group consisting of graphene nanoflakes, graphene nanoribbons, exfoliated graphite, reduced graphene oxide, split carbon nanotubes and combinations thereof.

11. The transparent electrode of claim 1, wherein the graphene film is a monolayer.

12. The transparent electrode of claim 1, wherein the graphene film comprises a plurality of layers.

13. The transparent electrode of claim 11, wherein the graphene film comprises from about two layers to about nine layers.

14. The transparent electrode of claim 1, further comprising a substrate.

15. The transparent electrode of claim 14, wherein the substrate is beneath the grid structure and the graphene film.

16. The transparent electrode of claim 14, wherein the substrate is selected from the group consisting of glass, quartz, boron nitride, silicon, plastic, polymers and combinations thereof.

17. The transparent electrode of claim 14, wherein the grid structure is positioned on a top surface of the substrate, and wherein the graphene film is positioned on a top surface of the grid structure.

18. The transparent electrode of claim 1, wherein the electrode has a transparency of more than about 70% in a wavelength region between about 400 nm and about 1200 nm.

19. A method of making a transparent electrode, wherein the method comprises:
a. providing a grid structure;
b. providing a graphene film; and
c. associating the graphene film with the grid structure.

20. The method of claim 19, wherein the grid structure is selected from the group consisting of metals, graphite, carbon nanotubes, amorphous carbons, metal particles, metal nanoparticles, metal microparticles, and combinations thereof.

21. The method of claim 19, wherein the grid structure is provided by one or more methods selected from the group consisting of evaporation, sputtering, chemical vapor deposition, inkjet printing, gravure printing, painting, photolithography, electron-beam lithography, soft lithography, stamping, embossing, patterning, and combinations thereof.

22. The method of claim 19, wherein the graphene film is provided by one or more methods selected from the group consisting of chemical vapor deposition growth, growth of a carbon source on a catalyst surface, reduction of graphene oxide, splitting of carbon nanotubes, spraying of graphene particles or precursors, and exfoliation of graphite.

23. The method of claim 19, wherein the graphene film is provided by growth of a carbon source on a metal surface.

24. The method of claim 19, wherein the graphene film is positioned on a top surface of the grid structure.

25. The method of claim 19, wherein the associating of the graphene film with the grid structure comprises an annealing step, wherein the annealing step adhesively associates the grid structure with the graphene film.

26. The method of claim 25, wherein the annealing step comprises a heat treatment of the transparent electrode structure.

27. The method of claim 25, wherein the method further comprises associating the transparent electrode with a substrate.

28. The method of claim 27, wherein the associating of the transparent electrode with the substrate comprises:
a. positioning the grid structure on a top surface of the substrate, and
b. positioning the graphene film on a top surface of the grid structure.

29. The method of claim 19, wherein the graphene film is provided by the spraying of graphene particles, wherein the graphene particles are selected from the group consisting of graphene nanoflakes, graphene nanoribbons, exfoliated graphite, reduced graphene oxide, split carbon nanotubes and combinations thereof.

30. The method of claim 29, wherein the graphene particles are sprayed onto a top surface of the grid structure.

31. The method of claim 29, wherein the method further comprises associating the transparent electrode with a substrate, and wherein the graphene particles are sprayed onto a top surface of the substrate.

32. The method of claim 19, wherein the graphene film is provided by the spraying of graphene precursors, wherein the graphene precursors are selected from the group consisting of graphene oxide nanoribbons and graphene oxide nanoflakes, and wherein the spraying is followed by a reduction step to convert the graphene precursors to graphene.

33. The method of claim 32, wherein the graphene precursors are sprayed onto a top surface of the grid structure.

34. The method of claim 32, wherein the method further comprises associating the transparent electrode with a substrate, and wherein the graphene precursors are sprayed onto a top surface of the substrate.

35. The method of claim 32, wherein the reduction step comprises at least one of treatment with heat or treatment with a reducing agent.

36. The method of claim 19, wherein the graphene film is provided by splitting carbon nanotubes.

37. The method of claim 36, wherein the splitting of carbon nanotubes occurs by the use of potassium metals.

38. The method of claim 37, wherein the splitting results in the formation of graphene oxide nanoribbons, and wherein the method is followed by a reduction step.
